(19) United States
(12) Patent Application Publication
(10) Pub. No.: US 2009/0231204 A1
(43) Pub. Date: Sep. 17, 2009

(54) MINIATURE ANTENNA FOR WIRELESS COMMUNICATIONS

(75) Inventors: George Shaker, Waterloo (CA); Mohammad-Reza Nezhad-Ahmadi, Waterloo (CA); Safieddin Safavi-Naeini, Waterloo (CA); Gareth Pryce Weale, New Hamburg (CA)

Correspondence Address: PEARNE & GORDON LLP, 1801 EAST 9TH STREET, SUITE 1200, CLEVELAND, OH, 44114-3108, US

(73) Assignee: AMI SEMICONDUCTOR, INC., Waterloo (CA)

(21) Appl. No.: 12/329,261

(22) Filed: Dec. 5, 2008

Related U.S. Application Data
(60) Provisional application No. 60/992,856, filed on Dec. 6, 2007.

(51) Int. Cl. H01Q 1/38; G06F 17/50; G06G 7/625

(52) U.S. Cl. 343/700 MS; 716/1; 703/13

(57) ABSTRACT

An antenna and a method for direct matching the antenna to a transceiver is provided. The method includes designing the antenna to directly match an antenna impedance to at least one of an input impedance of the transceiver and an output impedance of the transceiver. The step of designing includes modeling the antenna and the transceiver and implementing an electromagnetic field simulation using a human body phantom model with the antenna to determine the value of an antenna parameter for the antenna model. The antenna for a communication device having a transceiver, includes an antenna element directly coupled with the transceiver having a transmitter and a receiver, an antenna parameter of the antenna element being tuned so that the real part of the impedance of the antenna is maximized, and a plate for optimizing the reactive part of the impedance of the antenna. The impedance of the antenna is directly matched to at least one of an impedance of the transmitter and an impedance of the receiver. The method for antenna design includes providing estimate of a package, designing possible realization(s) of the antenna given the space limitations of the package to realize maximum power transfer around the head, for a given design of LNA and PA, generating power efficiency maps for all possible bias realizations versus all possible impedance values of the antenna, and modifying the antenna design in order to maximize the overall link efficiency.

### FIELD OF INVENTION

The present invention relates to antenna system, and more specifically to antennas for wireless communications, such as hearing aid, wireless implants and on-body based communication

### BACKGROUND OF THE INVENTION

Medical applications having communication capabilities are well known in the art. One of the applications is a hearing aid application. An antenna design is generally an important factor of its performance of the application. In antenna design for the medical applications, especially hearing aid application, it is challenging to design miniaturized and efficient antenna close to a human body. Electrically small antennas generally have high losses and require more powerful transmitters and complex high sensitivity receivers for satisfactory performance. The antennas need to meet the impedance requirements of receiver input and transmitter output.

### SUMMARY OF THE INVENTION

It is an object of the invention to provide a system and method that obviates or mitigates at least one of the disadvantages of existing systems.

In accordance with an aspect of the present invention, there is provided a method of direct matching an antenna to a transceiver. The method includes designing the antenna to directly match an antenna impedance to at least one of an input impedance of the transceiver and an output impedance of the transceiver. The designing includes modeling the antenna and the transceiver; and implementing an electromagnetic field simulation using a human body phantom model with the antenna model to determine the value of an antenna parameter for the antenna model.

In accordance with another aspect of the present invention, there is provided an antenna for a communication device having a transceiver. The antenna includes an antenna element directly coupled with the transceiver having a transmitter and a receiver, an antenna parameter of the antenna element being tuned so that the real part of the impedance of the antenna is maximized: and a plate for optimizing the reactive part of the impedance of the antenna. The impedance of the antenna being directly matched to at least one of an impedance of the transmitter and an impedance of the receiver.

In accordance with another aspect of the present invention, there is provided a method for antenna design. The method includes providing estimate of a package, designing possible realization(s) of the antenna given the space limitations of the package to realize maximum power transfer around the head, for a given design of LNA and PA, generating power efficiency maps for all possible bias realizations versus all possible impedance values of the antenna; and modifying the antenna design in order to maximize the overall link efficiency.

### BRIEF DESCRIPTION OF THE DRAWINGS

These and other features of the invention will become more apparent from the following description in which reference is made to the appended drawings wherein:

FIG. 1 is a diagram illustrating a human body phantom with an antenna in accordance with an embodiment of the present invention;

FIG. 2 is a diagram illustrating the human body phantom with the hearing aid packaged placed in ear;

FIG. 3 is a diagram illustrating admittance definitions for an LNA with bias circuits and an antenna;

FIG. 4 is a diagram illustrating admittance for the antenna of FIG. 3 with a matching inductor;

FIGS. 5A-5B are diagrams illustrating a model for transmit and receive sections in accordance with an embodiment of the present invention;

FIG. 6 is a diagram illustrating an antenna model with a bias circuit in accordance with an embodiment of the present invention;

FIG. 7 is a diagram illustrating a model for the antenna of FIG. 6 and a LNA in accordance with an embodiment of the present invention;

FIG. 8 is a diagram illustrating a reduced circuit model for the antenna of FIG. 7;

FIGS. 9A-9F are graphs illustrating examples of efficiency maps in accordance with an embodiment of the present invention;

FIG. 10 is a graph illustrating measured admittance elements for the LNA without an external bias circuit;

FIG. 11 is a graph illustrating one example of the admittance parameters of a designed antenna;

FIG. 12 is a graph illustrating another example of the admittance parameters of a designed antenna;

FIG. 13 is a diagram for calculating the input bandwidth as seen by the antenna in accordance with an embodiment of the present invention;

FIG. 14 is a graph illustrating input return loss as seen by the antenna;

FIG. 15 is a view illustrating one example of the antenna of FIG. 1;

FIG. 16 is a view illustrating another example of the antenna of FIG. 1;

FIG. 17 is a view illustrating a further example of the antenna of FIG. 1;

FIG. 18 is a view illustrating a further example of the antenna of FIG. 1;

FIG. 19A is a top view illustrating one example of an antenna layout for the antenna of FIG. 1;

FIG. 19B is a cross view for the antenna of FIG. 19A;

FIG. 20A is a top view illustrating another example of an antenna layout for the antenna of FIG. 1;

FIG. 20B is a cross view for the antenna of FIG. 20A;

FIG. 21 is a perspective view of one example of a hearing aid in accordance with an embodiment of the invention;

FIG. 22 is an exploded view of the hearing aid of FIG. 21;

FIG. 23 is a side view of the hearing aid of FIG. 21, with an example of excitation points;

FIG. 24 is a side view of the hearing aid of FIG. 21, with another example of excitation points; and

FIG. 25 is a flow chart showing a method of designing an antenna in accordance with an embodiment of the invention.

### DETAILED DESCRIPTION

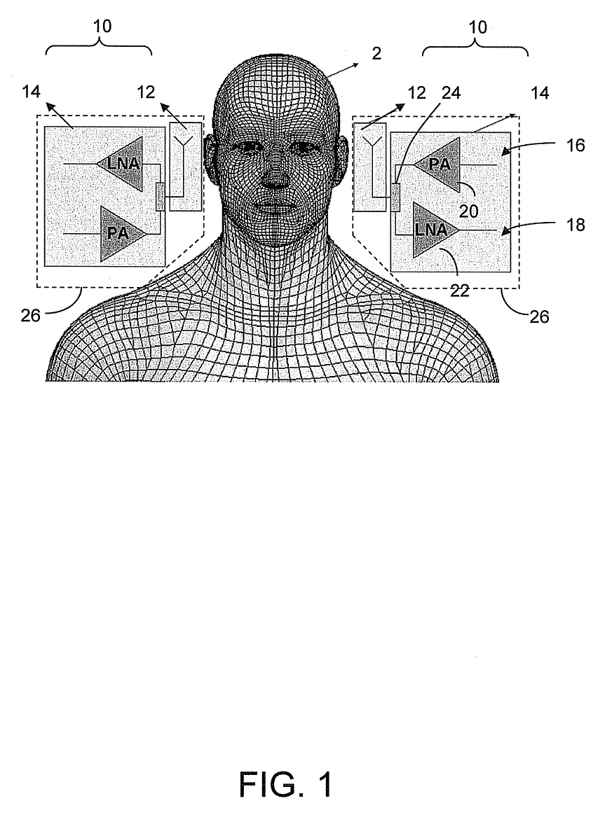

FIG. 1 illustrates a human body phantom with an antenna in accordance with an embodiment of the present invention. In FIG. 1, a hearing aid model 10 having an antenna model 12 and a transceiver model 14 is shown with a human body phantom 2. In the embodiment, an antenna is designed through an electromagnetic field simulation with the human body phantom 2.

The transceiver 14 includes a transmitter 16 and a receiver 18. The transmitter 16 includes a power amplifier (PA) 20. The receiver 18 includes a low noise amplifier (LNA) 22. The resultant antenna may be detachably connected to the transceiver though a port (24). The antenna 12 and the transceiver 14 are enclosed in a package 26. The antenna 12 and the transceiver 14 each may have a package. Each of the LNA and the PA may be on-chip amplifier.

In the description, the terms “antenna model” and “antenna” may be used interchangeably. In the description, the terms “hearing aid model” and “hearing aid” may be used interchangeably. In the description, the terms “human body”, “living body”, “body” and “user's body” are used interchangeably, and indicate a body of a living matter, such as an animal or a human's body. In the description, the term “body” may indicate a part of the body or a whole body. In the description, the terms “connect (connected)” and “couple (coupled)” may be used interchangeably. In the description below, the terms “antenna” and “antenna device” may be used interchangeably.

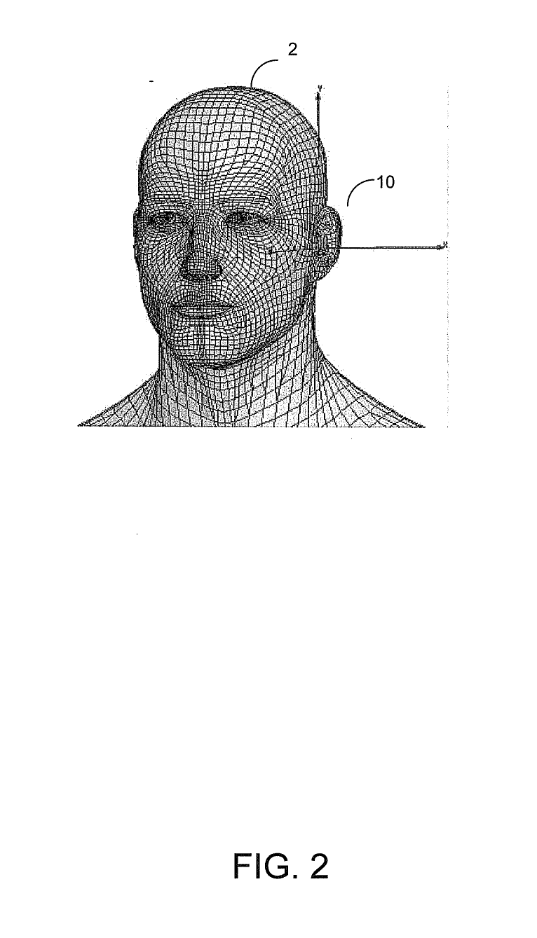

In one example, the hearing aid 10 may be placed to the back of each ear of the human head. In another example, the hearing aid 10 may be placed in each ear as shown in FIG. 2.

By using a paired set of hearing aid devices 10, enabling communication with each other, the set can maintain proper interpretation of the location of various sounds in the environment. The hearing aid devices can then coordinate the action of the directional, noise-reduction, feedback-cancellation, and compression systems to provide the train with a preserved set of pulses enabling it to re-create the asymmetric world of sound around the user of the hearing aid devices, despite his/her hearing loss asymmetry.

In the embodiment, the antenna is designed to use the human head as a part of the transmission medium The impedance of the antenna is tuned based on the human head properties. The antenna is first designed to maximize power transfer around the head, thus its impedance is tuned based on the human head properties. The antenna is then modified to realize maximization of a power transfer and matching to active circuitry (PA and LNA).

The human body phantom model 2 is used in Finite Element Simulations (FEM) for characterization of the electromagnetic propagation properties around the human head. The model is defined by, for example, an effective dielectric permittivity, permeability, and conductivity. In one example, a six layer head model (brain, cerebro spinal fluid, dura, bone, fat, skin) is used in the electromagnetic field simulations. Table 1 shows one example of the six layer head model. A simple spherical model is used, where the head is modeled as 6 different layers. The outer skin layer was changed in simulations to account for common differences in human heads, and also for different skin conditions, i.e., dry skin, oily skin, etc. The antenna (with package), is then placed around the human head. Simulations for different antennas are done to realize the best possible layout.

TABLE 1
Six Layer Head Model

| | Relative | Conductivity | Radius |
|---|---|---|---|
| Material | Permittivity | s/m | mm |
| Brain | 49.7 | 0.59 | 67.23 |
| Cerebro Spinal Fluid | 71 | 2.25 | 68.89 |
| Dura | 46.7 | 0.83 | 69.305 |
| Bone | 13.1 | 0.09 | 72.708 |
| Fat | 11.6 | 0.08 | 73.87 |
| Skin | 46.7 | 0.69 | 74.7 |

In one embodiment, an antenna is designed so as to have no external matching elements added to the network (direct matching). In another embodiment, an antenna is designed so as to have one matching element added (i.e, inductor or capacitor).

In the embodiment, the transceiver 14 and the antenna 12 are directly coupled to each other. The antenna is designed by incorporating direct matching technique. The antenna is not designed to be matched to the traditional 50 Ohms impedance. Instead, the antenna is designed to be matched to a driving chip impedance, without adding any matching network. The driving chip impedance may be the output impedance of the transmitter (e.g., the impedance of the PA chip 20), the input impedance of the receiver (e.g., the impedance of the LNA chip 22) or a combination thereof.

The antenna 12 is directly matched to, for example, but not limited to, a chipset designed to operate at the industrial, scientific and medical (ISM) band. However, the direct matching scheme can be used for direct matching of the antenna to the driving circuitry at any other band, extending its applicability to systems such as RFIDs and GPS circuits.

A part of the impedance matching is integrated with the antenna structure. This enhances the efficiency of the antenna because of the larger area of such antenna-integrated elements. Given the impedance of LNA or PA, the antenna is designed such that its impedance is matched to the active chipset. Part of the matching is realized using the bias elements as described below. The rest of it is lumped into the antenna inductance/capacitance.

The antenna is designed and optimized such that it couples maximum energy to another antenna on a symmetric location around the human head (e.g., behind the ear) as shown in FIG. 1. The optimization process includes, for example, incorporating all packaging effects These effects are found by comparing an antenna without package to that with a package. The optimization maximizes the real part of the input impedance of the antenna 12. The reactive part of the input impedance of the antenna 12 is optimized utilizing a floating sheet metallization for reactance tuning. In one example, the floating sheet metallization is implemented by a shield-like metallic plate so as to meet the values dedicated by efficiency maps.

In one example, the floating sheet metallization is implemented by a shield-like metallic plate. The shield-like metallic plate is placed in the antenna and is used in facilitating matching to the given chip impedance (e.g. impedance for LNA chipset, PA chipset or a combination thereof).

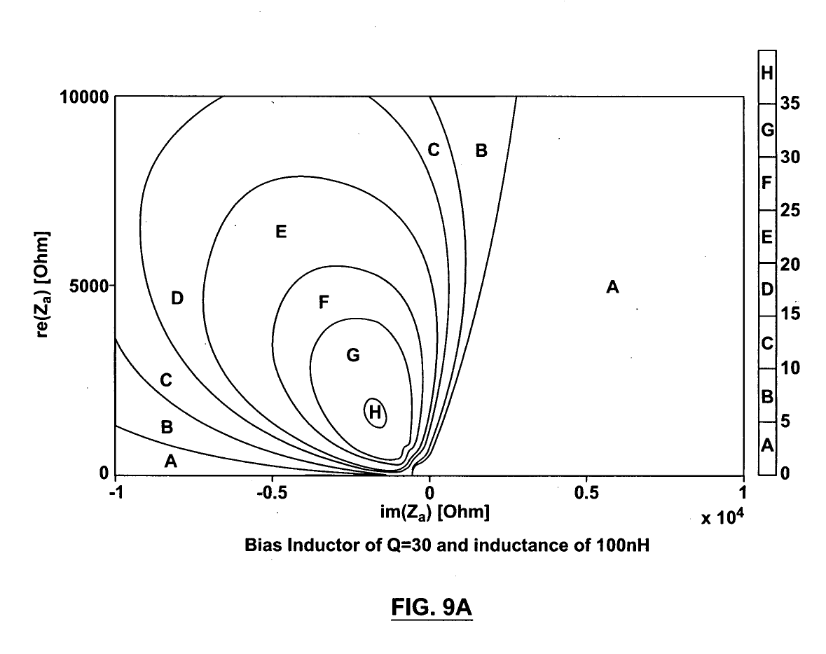

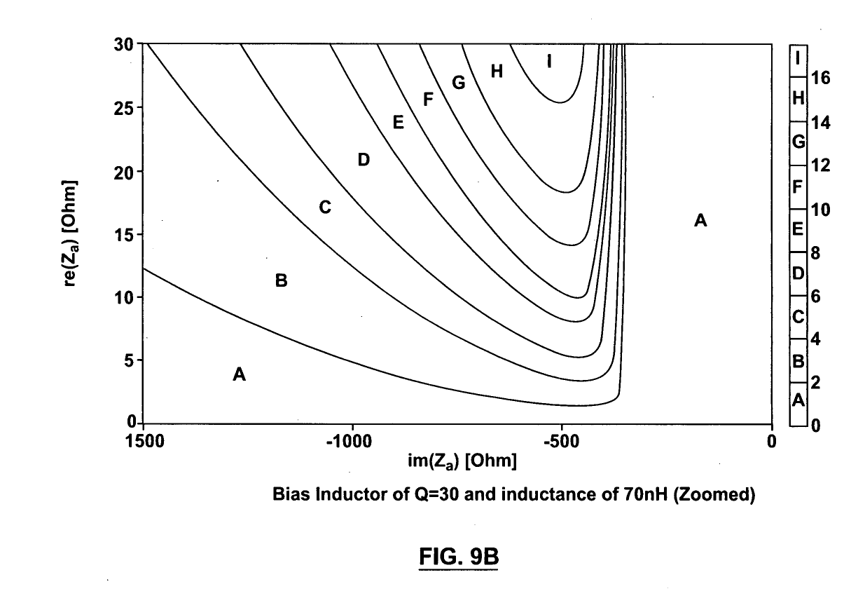

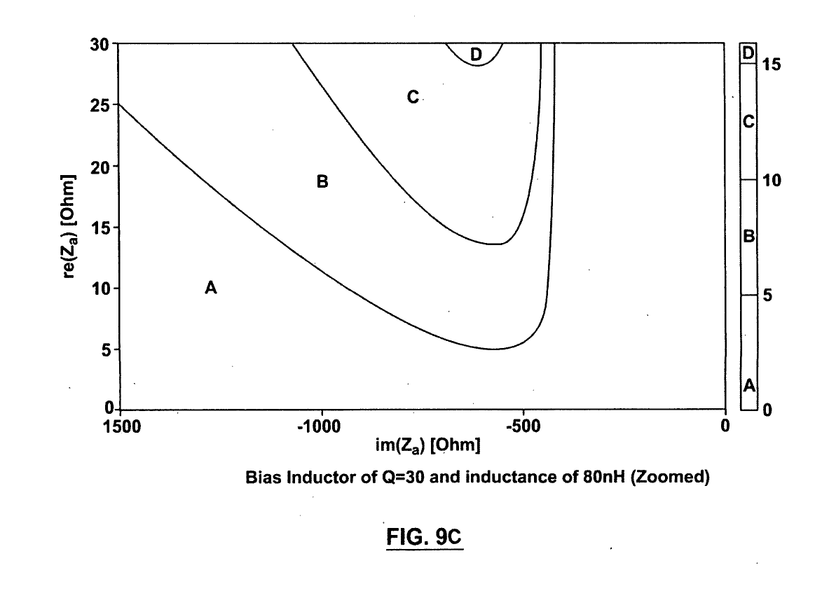

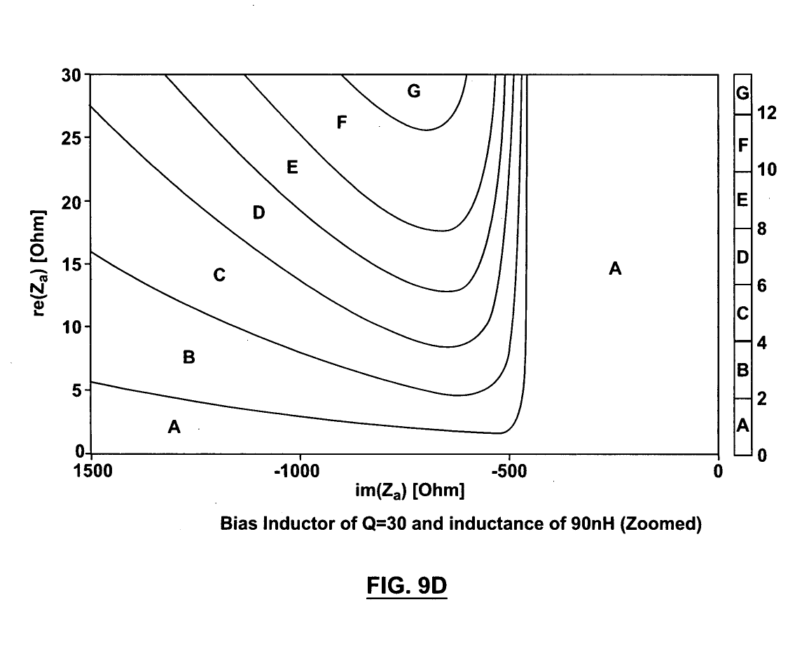

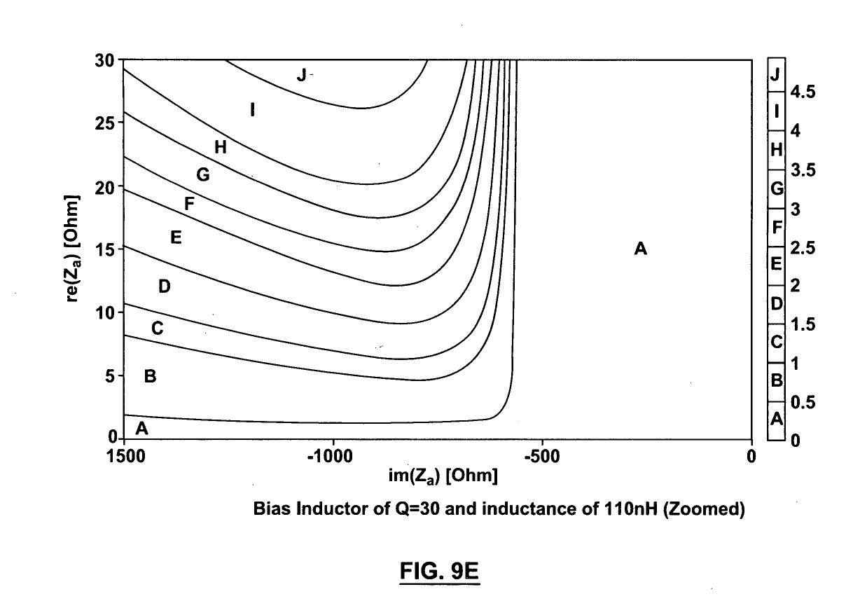

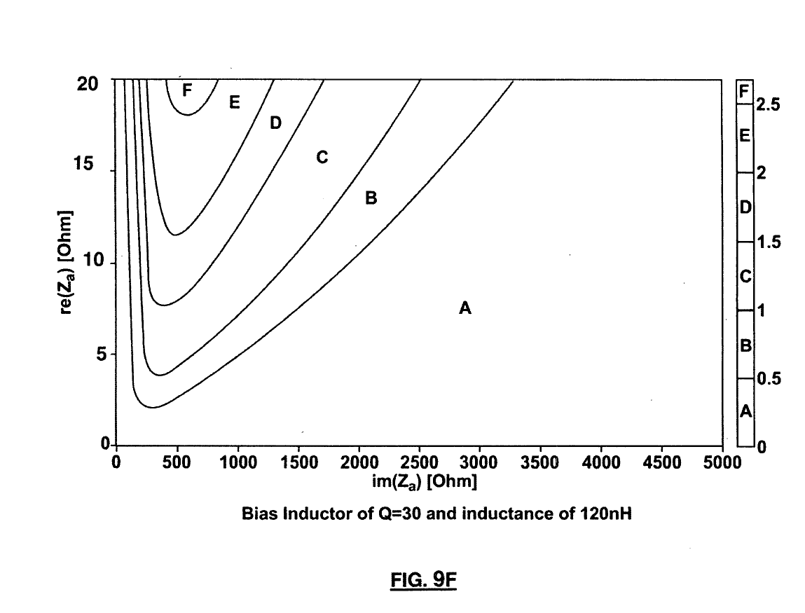

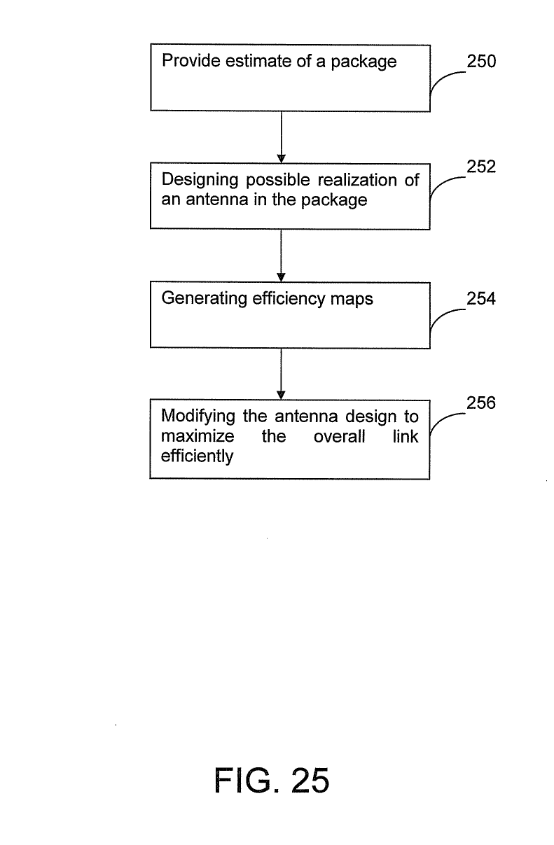

The efficiency maps are theoretical three dimensional maps (i.e., FIGS. 9A-9F) as described below, where when determining a bias inductor with a Q factor, ranges for the efficiency of the overall system can be directly calculated, dedicating the values of the antenna resistance and reactance corresponding to any efficiency value. These maps are utilized along with maximizing the electromagnetic radiation from one antenna to the other, to maximize the overall system efficiency. The maps are used as described below and illustrated in FIG. 25.

The efficiency maps were studied for the cases of adding one matching element to the circuitry as described below, and for the cases where direct matching is applied without need for any matching network. As described above, there are two possible scenarios for matching: one is to have no external matching elements added to the network (direct matching), and the other is to have one matching element added (i.e., inductor or capacitor.) Efficiency maps are utilized in both scenarios.

Thus, the antenna is designed to maximize both the circuit efficiency and electromagnetic link efficiency with direct matching of the antenna 12 to the circuitry, e.g., active circuitry.

The resultant antenna includes a shield-like metallic plate, which is used in facilitating matching to the given chip impedance (e.g. impedance for LNA chipset, PA chipset or a combination thereof).

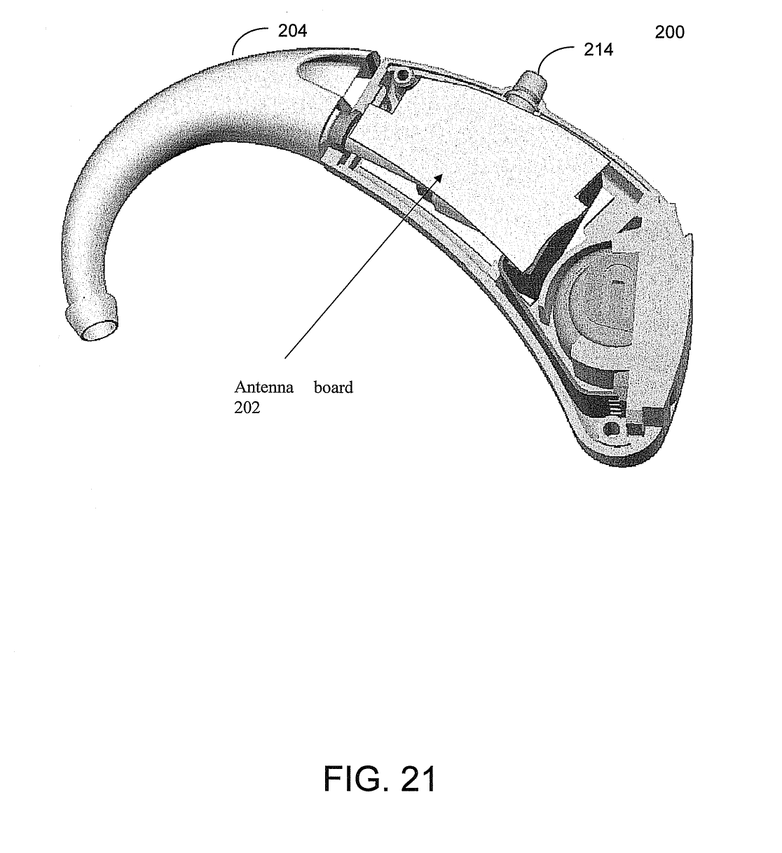

The antenna is designed on three dimensional flexible materials conforming to the hearing aid package 26. The examples of the packaging are shown in FIGS. 21-24 and described below.

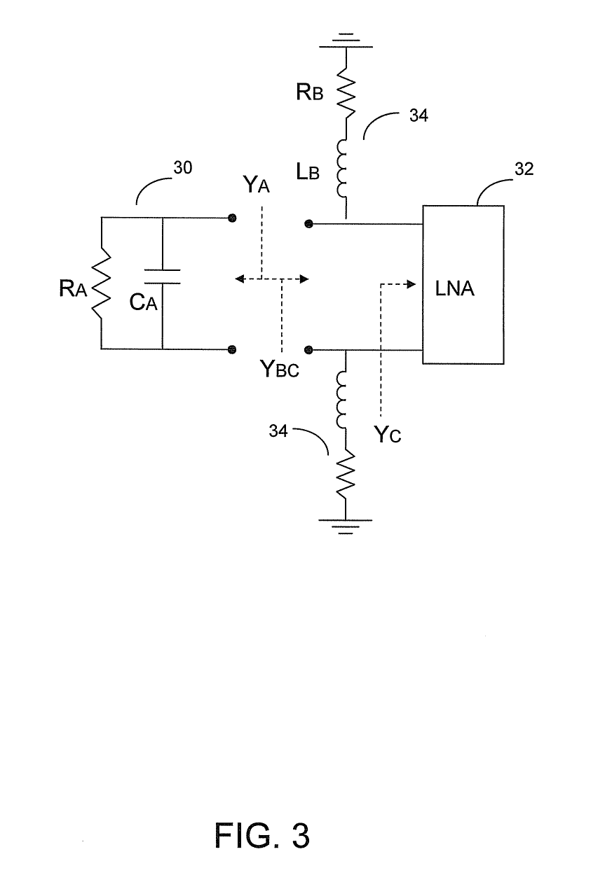

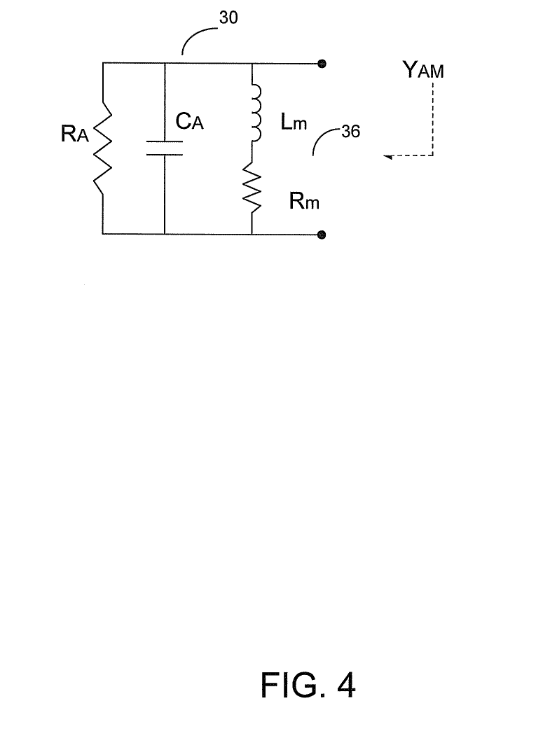

The direct matching technique is described in detail. FIGS. 3-4 illustrate one approach to match an antenna to a LNA. Referring to FIGS. 3-4, one approach to match an antenna 30 to a LNA 32 is to use bias inductors 34 to achieve parallel resonance (anti-resonance) of the input impedance at the terminals of the bias-LNA circuitry for a desired frequency. This is done by Im (YBC)=0 in FIG. 3. Next the antenna is designed such that the real part of its admittance is the same as that of the bias-LNA at resonance. The capacitive part of the antenna admittance is then removed by adding an inductor 36 to resonate the antenna as well at the resonant frequency as shown in FIG. 4. It is assumed that when connecting of both of the antenna with its matching inductor 36 and the bias-LNA circuit, that matching between the antenna and the LNA 32 can be achieved.

By contrast, in an embodiment of the present invention, instead of using a matching network, the matching is inherently embedded into the antenna 12 of FIG. 1, resulting in eliminating the need for an extra matching element (e.g., matching inductor 36 of FIG. 4) on the antenna 12.

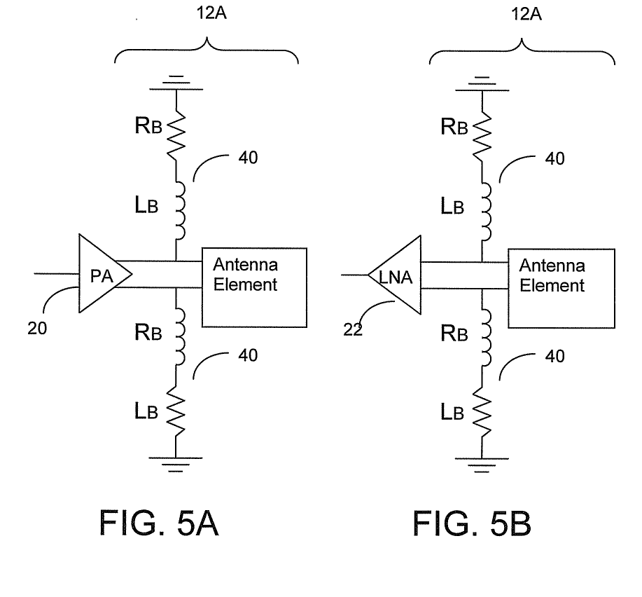

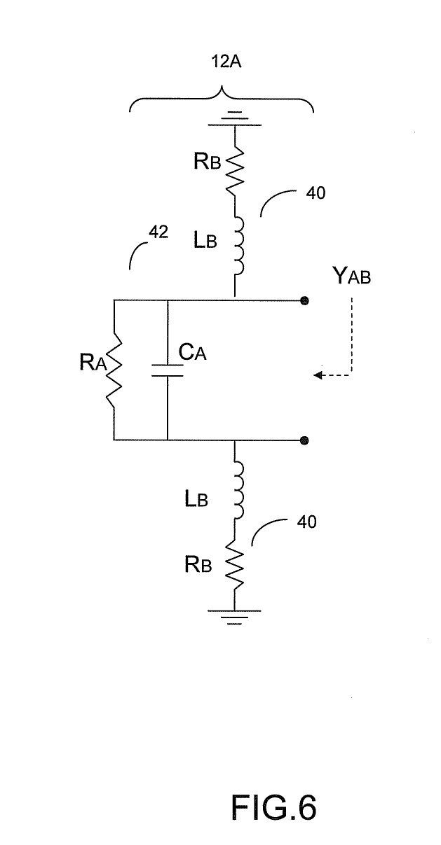

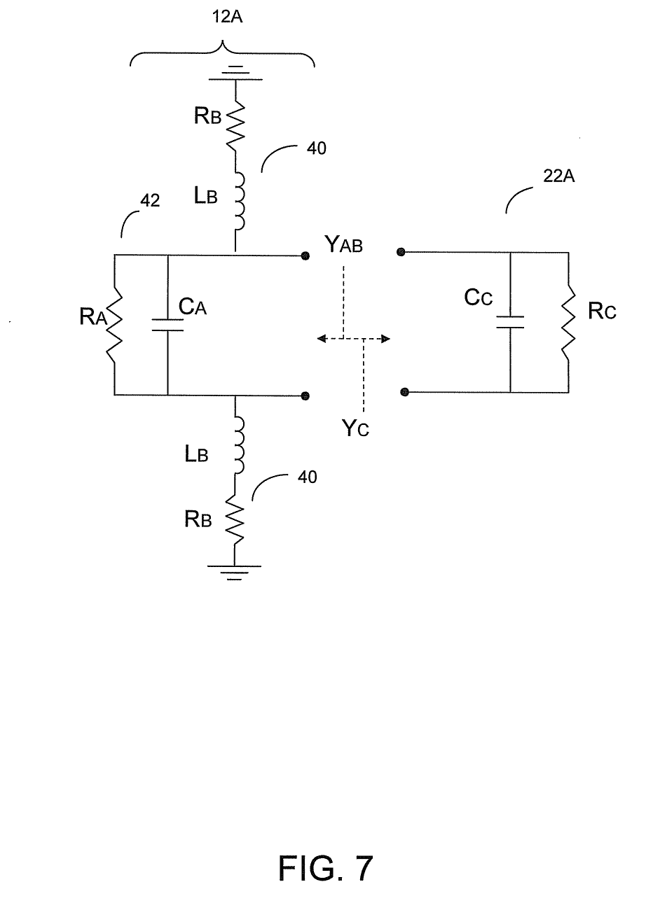

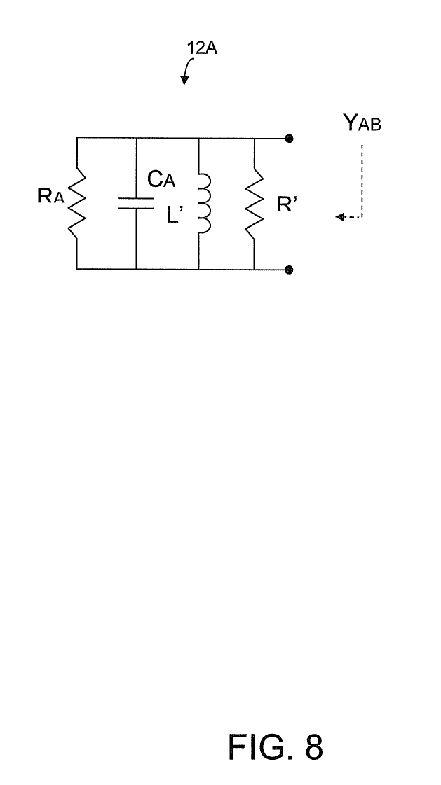

In one embodiment, the model 12A of FIG. 5 is used for the design of the antenna, in order to assess the communication link featuring direct matching. The antenna model 12A is connectable to the LNA 22 and PA 20. In the model 12A, a bias circuit 40 is on the antenna side. In one simulation, the antenna model 12A is replaced with its equivalent admittance as shown in FIG. 6. In the simulation, the PA 20 and the LNA 22 of FIG. 5 are replaced with their equivalent admittances. For example, the model of FIG. 5 is modified as shown in FIG. 7 using a LNA 22A. FIG. 8 illustrates a reduced circuit for the antenna 12A with the bias circuit 40 for the LNA 22A. The bias circuit is modeled on the antenna side as a parallel inductor and its associated resistance.

For example, in order to match the LNA 22A to the antenna 12A for maximum power transfer, the admittance YAB for antenna element and the bias circuit 40 meets:

YAB=Y*C (1)

where Yc is the admittance for the LNA 22A and the “*” denotes a complex conjugate.

By investigating the imaginary parts of (1), the following equations are set:

jwCA+1/jwL′=−jwCc (2)

L′=1/{w²(Cc+CA)} (3)

where

$$\begin{matrix}{L}^{′} = 2 * \{ {R}_{B}^{2} + {( w {L}_{B} )}^{2} \} / {w}^{2} {L}_{B} & ( 4 ) \\ = 2 * \{ {( w {L}_{B} / Q )}^{2} + {( w {L}_{B} )}^{2} \} / {w}^{2} {L}_{B} & ( 5 ) \\ = 2 * \{ {( 1 / Q )}^{2} + 1 \} {L}_{B} & ( 6 )\end{matrix}$$

where “L′” represents the reactive part of the impedance for the bias circuit 40, and Q is the quality factor of the bias inductor LB.

Hence the following equation is obtained:

LB=*½*1/{(1/Q)²+1}*1/w²*1/(CC+CA) (7)

This relation is used to find the bias inductance needed as the first step on matching the antenna 12A to the LNA 22A. The next step in ensuring matching is to have equal real parts of the admittances. This is done by:

1/RA+1/R′=1/RC (8)

where

$$\begin{matrix}{R}^{′} = 2 * \{ {R}_{B}^{2} + {( w {L}_{B} )}^{2} \} / {R}_{B} & ( 9 ) \\ = 2 * \{ {( w {L}_{B} / Q )}^{2} + {( w {L}_{B} )}^{2} \} / ( {w}^{2} {L}_{B} / Q ) & ( 10 ) \\ = 2 * {L}_{B} * \{ w / Q + w Q \} & ( 11 )\end{matrix}$$

and where “R′” represents the resistive part of the impedance for the bias circuit 40.

Using L′ and R′, the antenna impedance Za can be expressed. The efficiency maps of FIGS. 9A-9F show the relationship between the imaginary part of an antenna impedance, im(Za), and the real part of the antenna impedance, re(Za), by changing the values.

The efficiency maps coupled with Table 1 of the simulated performance of antennas around the human head serve in predicting the performance of the system in terms of power transmission, sensitivity to variation in circuit elements, and sensitivity to variations in the human head. Higher bias inductor values may degrade the circuit overall power transfer when a small antenna is directly connected to the active circuitry as shown in the efficiency maps in FIGS. 9A-9F.

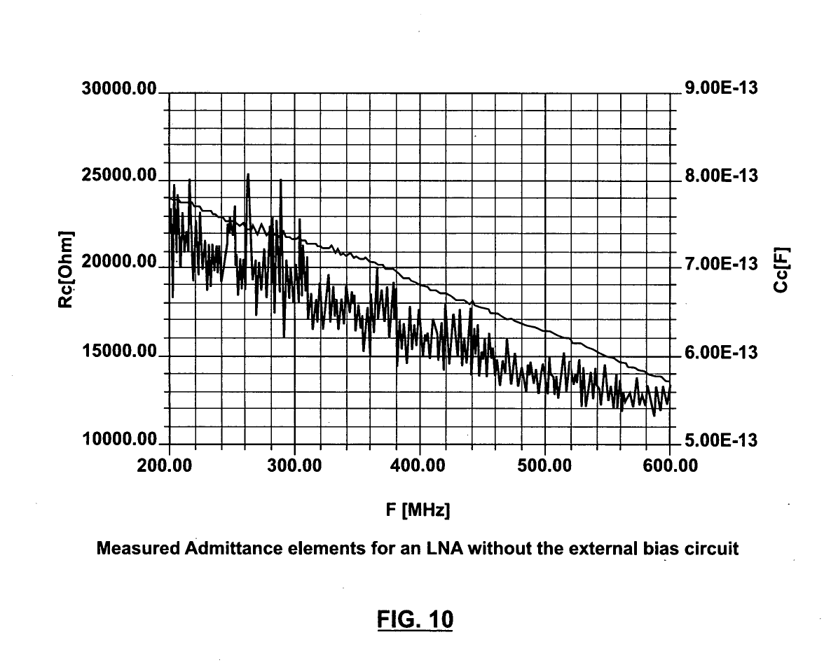

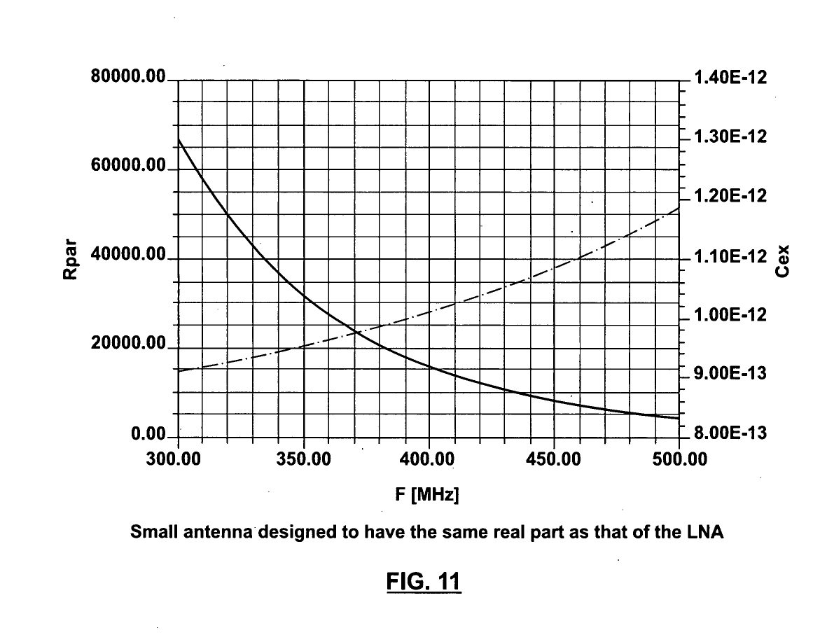

Antenna design examples are described in detail. Given the measured admittance parameters of the LNA (FIG. 10) between 200 MHz and 600 MHz, a small antenna with a size of about one twentieth of the wavelength covering both the transmit and receive bands of the 400 MHz ISM band (400-410 MHz) was designed for direct connection to the active circuitry.

Inspecting the measured results of the LNA chipset at the mid-band (405 MHz), Rc=17045 [Ω] and Cc =−6.779e⁻¹³[F]. The admittance parameters of a designed antenna for a bias of 50 nH and Q=30, yielding a 10% circuit efficiency are RA′=18036 [Ω] and CA=1.016577e⁻¹²[F], that is the antenna impedance of Za=Ra+jXa=88.973−j402.2[Ω]. Accounting for the circuit efficiency, such antenna is capable of receiving 1.0729e-6[W] for 1 Watt source, if connected directly to the PA and LNA on the transmit and receive sides respectively. FIG. 1 shows the admittance parameter of a designed antenna with RA=18036 [Ω] and Cc=9.76577e⁻¹³[F].

Assuming a typical conductor quality factor of 50, an inductor of LB is 45.52e⁻⁹[H] to achieve resonance (Im(Y)=0). If the quality factor is taken into consideration, RB is 2.345[Ω]. The antenna will see a conductance of 1/Rc+1/R′, and thus mismatch will occur at the desired frequency. In particular, if R′=11736[H], the overall resistance of Rc//R′=6950[Ω] instead of 18036.

The antenna is first designed to maximize power transfer around the head, given a bias value, and ignoring the quality factor of the bias inductor. Thus, for a realistic system, the antenna may be mismatched due to the effect of the Q factor of the inductor. Thus, an iterative design is applied to match a given antenna to the LNA with real world bias network.

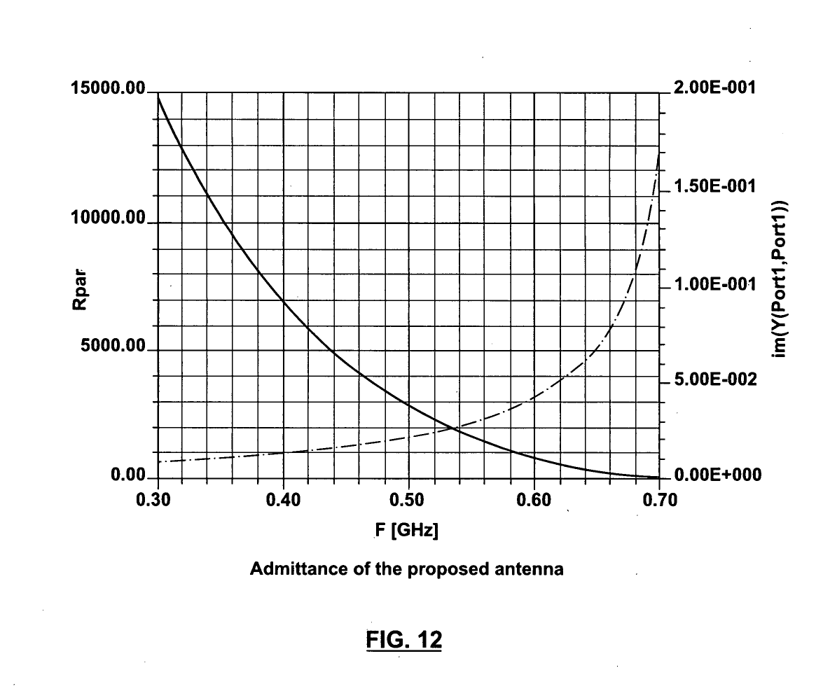

If the value of Rc//R′=6950[Ω] is a next iteration design target for RA and knowing the for small antenna, the value of Cc does not suffer a huge shift, another design of RA=6978.58[Ω] and Cc=1.206e⁻¹²[F] is obtained. FIG. 12 illustrates admittance plots for another designed antenna.

These values require a bias and matching inductor of LB=39.97e⁻⁹[H] with RB=2.0594[Ω], yielding Rc//R′=6422.39[Ω]. It can be seen that this value is sufficient to achieve matching to the re-designed antenna of RA=6978.58[Ω].

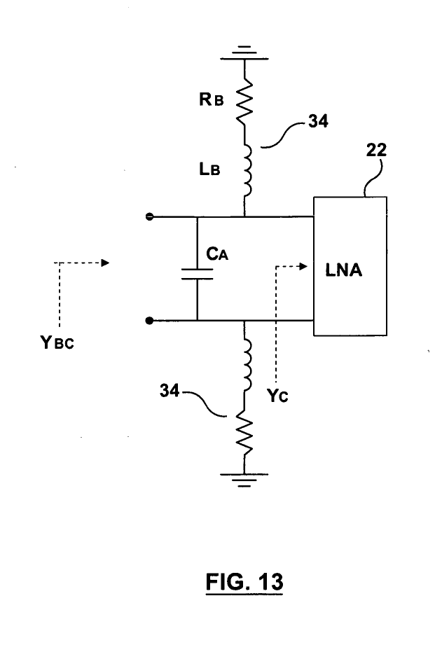

FIG. 13 illustrates a schematic for calculating the return loss using the antenna with the LNA. The return loss calculated is defined by:

S₁₁[dB]=20 log {{(1/RA)−Ym)/((1/RA)+Ym)} (12)

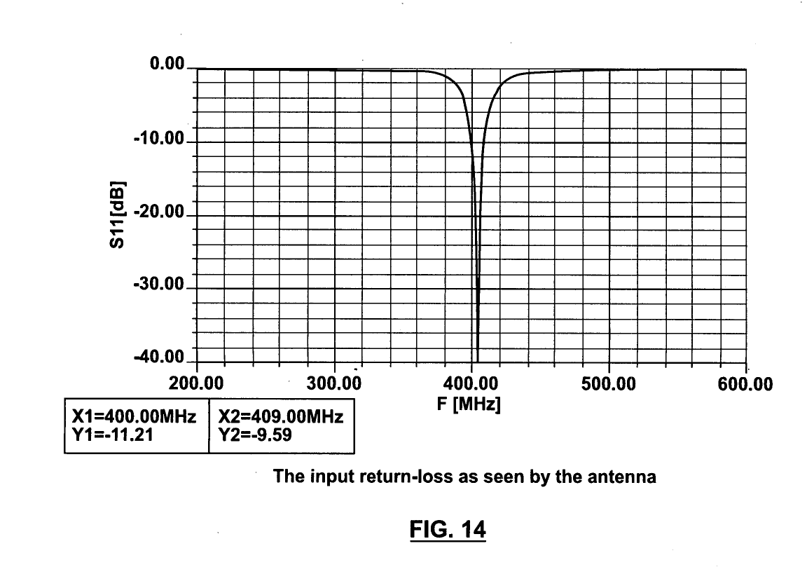

FIG. 14 illustrates input return loss as seen by the antenna. FIG. 14 clearly indicates that matching is achieved, and VSWR less than 2 covers the required 10 MHz bandwidth centered around 405 MHz. Frequency independent RA and CA are assumed while the frequency dependent values for the bias and chip admittances are used in the above. Such simplification is justified when noting that the antenna capacitance does not change significantly, (same holds for its resistance) within the desired band of operation, which in turn means that the results achieved above are within a reasonable accuracy.

Test setting up for the antenna for the hearing aid may be accomplished by cascading the antenna and a BALUN model to extract the overall impedance and compare it with the measured overall impedance.

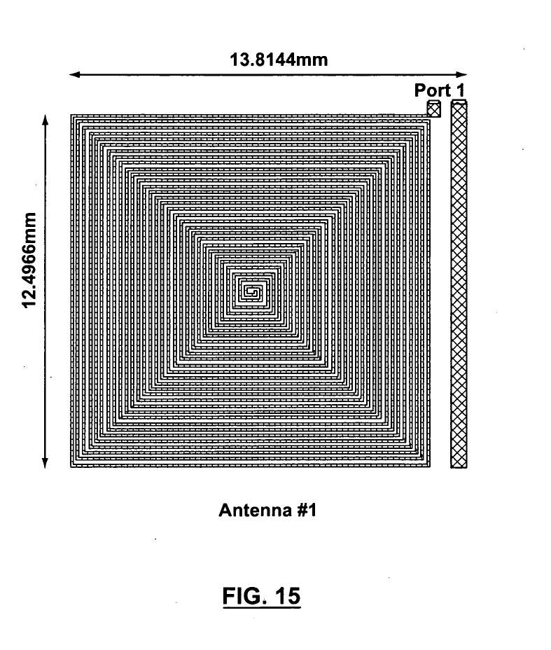

FIGS. 15-18 illustrate examples of the resultant antenna from the antenna model 12 of FIG. 1. The antennas of FIGS. 15-18 are example only. The configuration of the antenna may vary depending on the design requirements as described herein.

The antenna 100 of FIG. 15 includes a metallic trace 102 that is meandered (i.e., a plurality of turns). The antenna 100 includes port(s) 104 that is coupled to the transceiver (14 of FIG. 1).

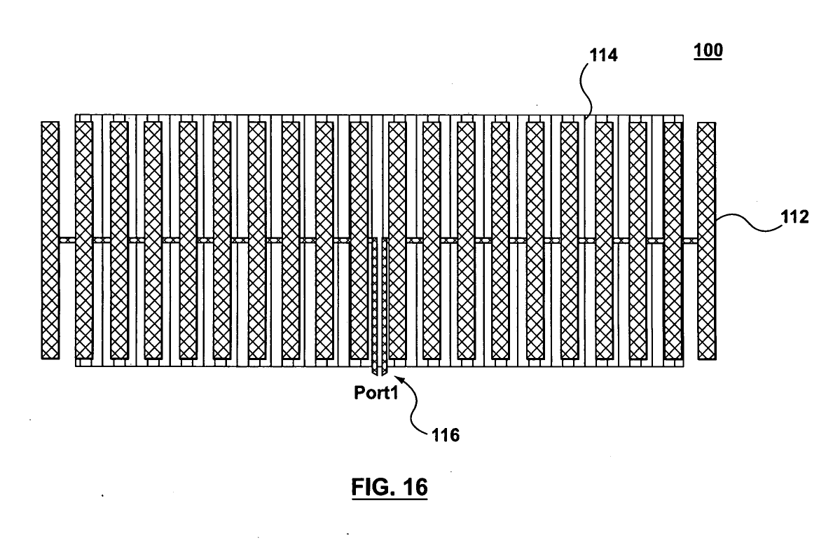

The antenna 110 of FIG. 16 includes a plurality of metallic strips 112. The widths of the metallic strips 112 are varied. At least two of the metallic strips 112 have different widths. The metallic strips 112 are connected to port(s) 116 that is connected to the transceiver (14 of FIG. 1). The structure of the metallic strips are tuned to optimize the impedance of the antenna. The metallic strips 112 are backed by a large metallic piece (a shield like metallic plate 114) to aid in shielding.

The antenna 120 of FIG. 17 includes main meandered metallic traces 122 and metallic strips 124. The main meandered traces 122 aid in achieving the required input impedance. The metallic strips 124 may be used in fine tunings. The antenna 120 is connected the transceiver (14 of FIG. 1) through to port(s) 126.

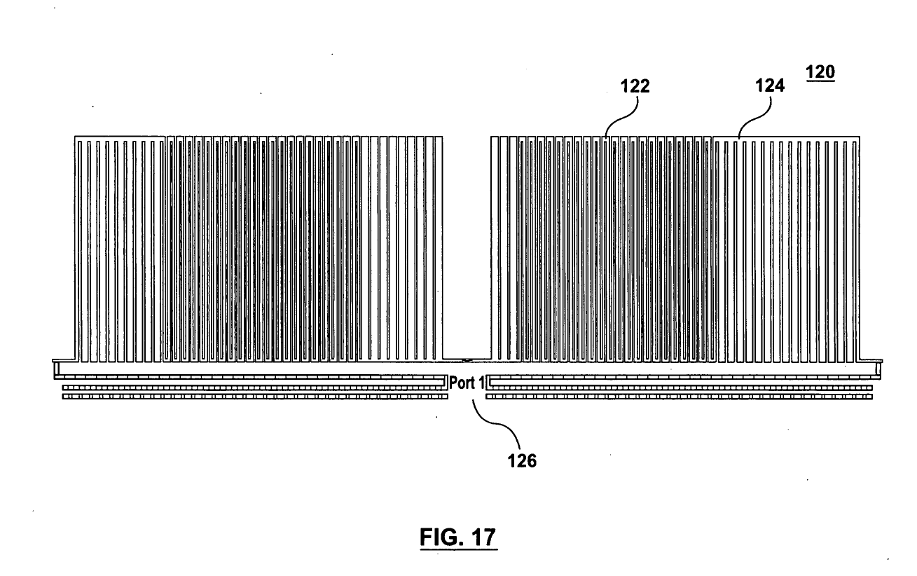

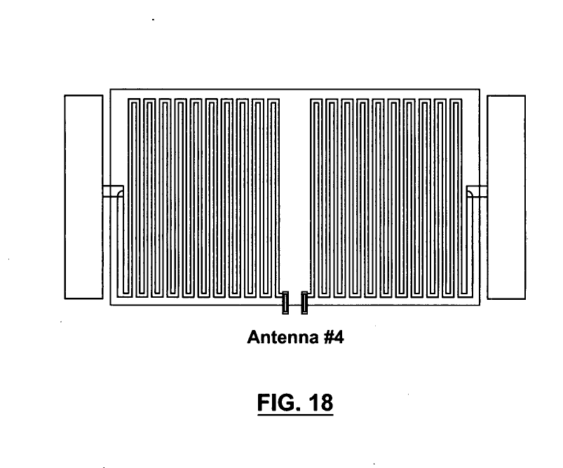

The antenna 130 of FIG. 18 is also an example of the antenna obtained from the design process described herein.

Referring to FIGS. 15-18, the exact length of each component are post tuned based on the results of the simulation. The impedance level is determined by the amount of meandering and the metallic strip used.

Based on the sturdy of small antenna around the human head, along with the study seeking maximization of the system power transfer through selecting appropriate values for the antenna impedance, corresponding to a given bias inductance, four antenna layouts were developed.

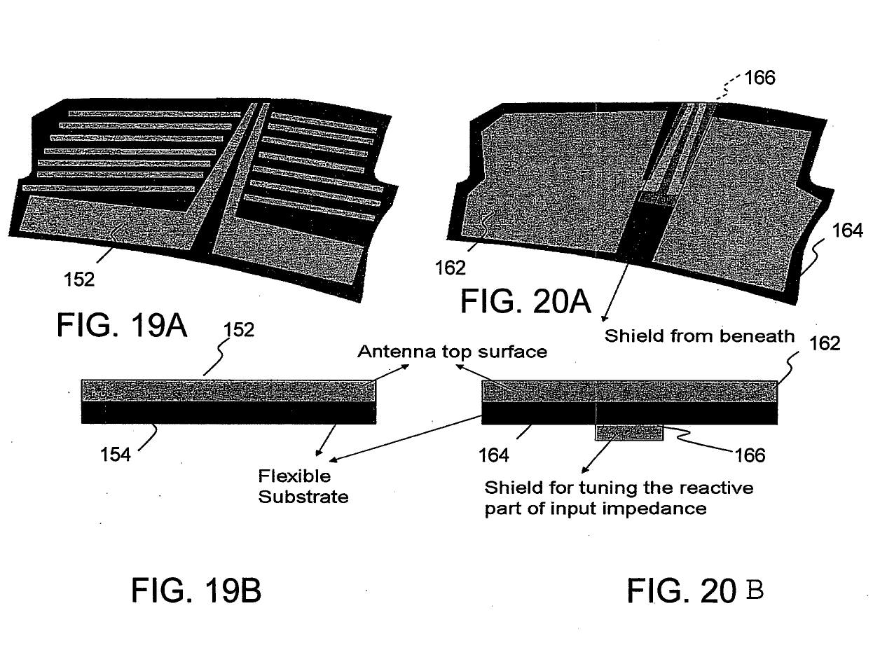

FIG. 19A is a top view of one prototype for fabrication of the antenna for a hearing aid application. FIG. 19B is a cross section view of the antenna of FIG. 19A. The antenna 150 of FIG. 19A-18B includes an antenna top surface 152 and a flexible substrate 154. The antenna 150 includes a plurality of non-connected arms for post fabrication quick tunings with, for example, copper tapes.

FIG. 20A illustrates another example of a prototype for fabrication of the antenna for a hearing aid application. FIG. 20B is a cross section view of the antenna of FIG. 20A. The antenna 160 of FIG. 20A-20B includes an antenna top surface 162, a flexible substrate 164 and a shield 166 for tuning the reactive part of input impedance.

Referring to FIGS. 19A, 19B, 20A, and 20B, the antennas 150 and 160 are based on dipoles. Assuming 50 [nH] (Q=30) bias inductors, these antennas can be directly connected to the active circuitry. To operate at 50 [nH], each of the antennas are fabricated in two sets, each fitted on a side of the package, and connected together.

The antennas 150 and 160 are capable of realizing a simulated power reception level of around, for example, −69.5 [dB] and −67[dB], when included in the hearing aid package (26 of FIG. 1) and placed closed to the human body phantom model (2 of FIG. 1).

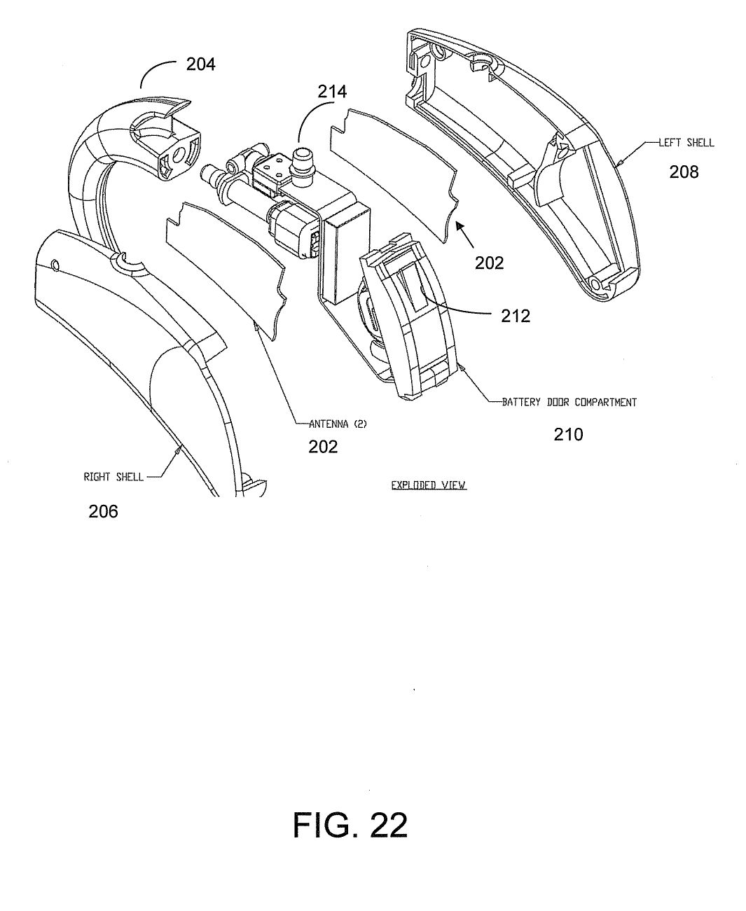

FIGS. 21-24 show some examples of a hearing aid device in accordance with an embodiment of the present invention. The hearing aid device 200 of FIGS. 21-22 includes an antenna board (antenna) 202. The hearing aid device 200 of FIGS. 21-22 has a tone hook 204, a right shell 206, a left shell 208, a battery door compartment 210 with an on/off switch, a volume control bottom 214. The antenna 202 is enclosed in the shells 206 and 208.

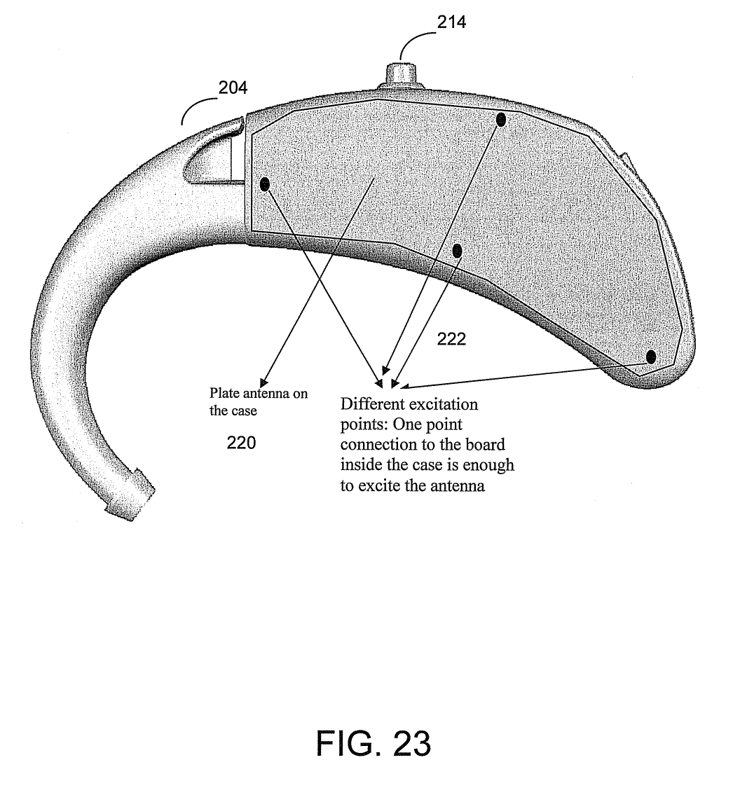

As shown in FIG. 23, the hearing aid device may include a plate antenna 220 as shown in FIG. 23, and has a plurality of different excitation points 222. One point connection to the board inside the case (shell) is enough to excite the antenna 220.

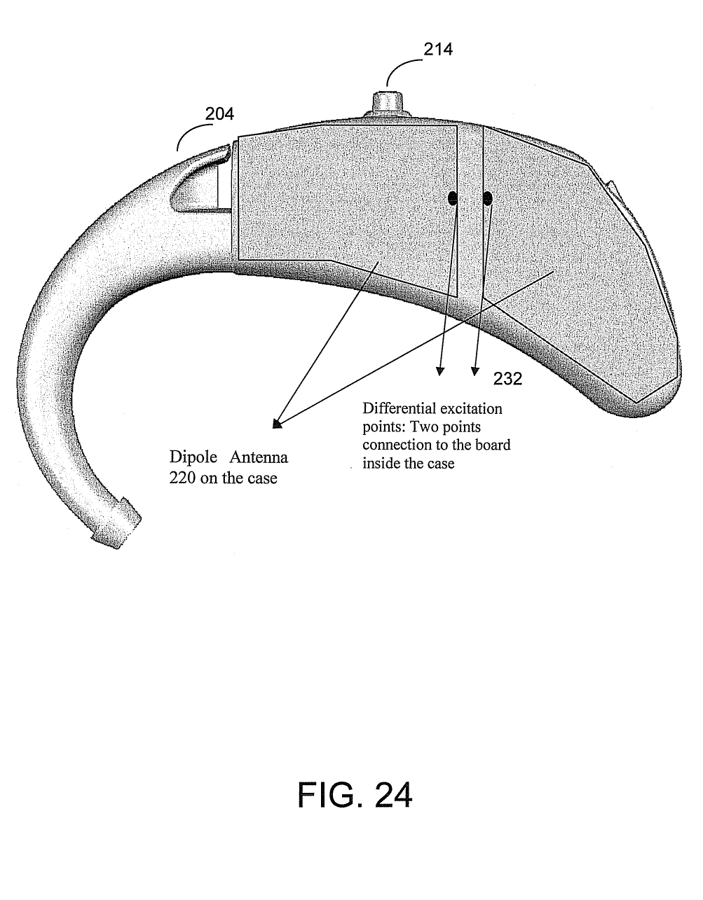

As shown in FIG. 24, the hearing aid device may include a dipole antenna 230 as shown in FIG. 24, and has a plurality of different excitation points 232. One point connection to the board inside the case (shell) is enough to excite the antenna 230.

FIG. 25 shows one example of a method of designing an antenna in accordance with an embodiment of the invention. One example of designing an antenna is descried, with reference to FIG. 21. In the first step (250), estimate of the package (size/material) is provided. In the second step (252), possible realization(s) of the antenna is designed, given the space limitations of the package, to realize maximum power transfer around the human head. In the third step (254), for a given design of LNA and PA, power efficiency maps are generated for all possible bias realizations versus all possible impedance values of the antenna. The efficiency maps will guide as a sensitivity measure of the overall link efficiency. In the third step (256), the antenna design is modified in order to maximize the overall link efficiency. This is determined by maximizing the combination of the power transfer around the human head, establishing direct matching to the LNA/PA, and reducing the system sensitivity to variations in human head sizes and package tolerances.

The embodiments of the present invention are further clarified in “Antenna For AMIL Semiconductors Hearing Aid Devices: Analysis and Design Optimization: Proposed Antenna Solution” as shown below. The contents of “Antenna For AMIL Semiconductors Hearing Aid Devices Analysis and Design Optimization: Proposed Antenna Solution” form a part of the detailed description.

One of the embodiments is further clarified in “Direct Matching of a Miniaturized Antenna of an On-Chip Low Noise Amplifier” as shown below. The contents of “Direct Matching of a Miniaturized Antenna of an On-Chip Low Noise Amplifier form a part of the detailed description.

One of the emobodiments is further in “On Design of a Hearing Aid Communication System” as shown below. The contenets of “On Design of a Hearing Aid Communication System” form a part of the detailed description.

One or more currently preferred embodiments have been described by way of example. It will be apparent to persons skilled in the art that a number of variations and modifications can be made without departing from the scope of the invention as defined in the claims.

What is claimed is:

1. A method of direct matching an antenna to a transceiver, comprising:
designing the antenna to directly match an antenna impedance to at least one of an input impedance of the transceiver and an output impedance of the transceiver, including:
modeling the antenna and the transceiver; and
implementing an electromagnetic field simulation using a human body phantom model with the antenna model to determine the value of an antenna parameter for the antenna model.

2. A method as claimed in claim 1, wherein the step of implementing comprises:
determining the value of the antenna parameter for the antenna model based on an efficiency map.

3. A method as claimed in claim 1, wherein the step of designing comprises:
designing the antenna so that the antenna couples maximum energy to another antenna around a human head.

4. A method as claimed in claim 3, wherein the step of designing comprises:
optimizing the antenna parameter to maximize the real part of the input impedance of the antenna in parallel to maximizing the antenna efficiency.

5. A method as claimed in claim 4, wherein the step of designing comprises:
optimizing the antenna parameter by incorporating a packaging effect.

6. A method as claimed in claim 3, wherein the step of designing comprises:
tuning the reactive part of the input impedance of the antenna, including optimizing the reactive part of the input impedance of the antenna by a floating sheet metallization for reactance tuning.

7. An antenna for a communication device having a transceiver, comprising:
an antenna element directly coupled with the transceiver having a transmitter and a receiver, an antenna parameter of the antenna element being tuned so that the real part of the impedance of the antenna is maximized: and
a plate for optimizing the reactive part of the impedance of the antenna,
the impedance of the antenna being directly matched to at least one of an impedance of the transmitter and an impedance of the receiver.

8. An antenna as claimed in claim 7, wherein the antenna element comprises:
a metal strip

9. An antenna as claimed in claim 7, wherein the antenna element comprises:
a metal meandered trace

10. An antenna as claimed in claim 7, wherein the antenna element comprises:
a plurality of metal strips

11. A method for antenna design, comprising:
providing estimate of a package;
designing possible realization(s) of the antenna given the space limitations of the package to realize maximum power transfer around the head;
for a given design of LNA and PA, generating power efficiency maps for all possible bias realizations versus all possible impedance values of the antenna; and
modifying the antenna design in order to maximize the overall link efficiency.

12. A method as claimed in claim 11, wherein the step of modifying comprises:
using the maps so that the maps guide as a sensitivity measure of the overall link efficiency.

13. A method as claimed in claim 11, wherein the step of modifying comprises:
maximizing the combination of the power transfer around the human head, establishing direct matching to the LNA/PA, and reducing the system sensitivity to variations in human head sizes and package tolerances.
